(19) United States
(12) Patent Application Publication
(10) Pub. No.: US 2022/0065030 A1
(43) Pub. Date: Mar. 3, 2022

(54) SPLIT IRON FRAME DOOR STRUCTURE

(71) Applicant: Ningbo Tengyu Metal Product Co., Ltd., Ningbo City (CN)

(72) Inventors: Peike ZHANG, Ningbo City (CN); Junhua Jiang, Ningbo City (CN); Yechen Xu, Ningbo City (CN); Zhewei Wu, Ningbo City (CN); Lei Ying, Ningbo City (CN)

(21) Appl. No.: 17/341,618

(22) Filed: Jun. 8, 2021

(30) Foreign Application Priority Data
Apr. 9, 2020 (CN) 202020513352.8

(51) Int. Cl. E06B 3/72; E06B 3/46

(52) U.S. Cl. CPC E06B 3/72; E06B 3/4636

(57) ABSTRACT

There provides a split iron frame door structure including top, middle and bottom split frames. A top edge frame and two side edge frames of the top split frame, two side edge frames of the middle split frame, and a bottom edge frame and two side edge frames of the bottom split frame are thin-wall square tubes. A transversely-arranged first flat-iron edge frame is fixed to the bottom of the top split frame. Transversely-arranged second and third flat-iron edge frames are fixed to the top and the bottom of the middle split frame, respectively. A transversely-arranged fourth flat-iron edge frame is fixed to the top of the bottom split frame. The first and second flat-iron edge frames are detachably connected through a first I-shaped section material and first connecting screws. The third and fourth flat-iron edge frames are detachably connected through a second I-shaped section material and second connecting screws. The iron frame door structure adopts a split design, and is low in packaging cost and transportation cost, light in overall weight, concise in appearance and good in light transmittance.

### TECHNICAL FIELD

The disclosure relates to an iron frame door structure, and specifically relates to a split iron frame door structure.

### BACKGROUND ART

At present, an iron frame door provided with glass in the market is usually welded and assembled as a whole before leaving a factory, and this iron frame door is packaged wholly when leaving the factory. So, the packaged iron frame door is large in size, the logistics transportation is inconvenient, and the transportation cost is high. In addition, a thickness of the material for the frame of the iron frame door is thick, so that the iron frame door is heavy. And meanwhile, the area of the glass is reduced to a certain extent because the thickness of the material of the frame is thick, thus the iron frame door has the problem that the light transmittance thereof is low.

### SUMMARY

The technical problem to be solved by the disclosure is to provide a split iron frame door structure in view of the defects in the prior art. The top split frame, a middle split frame and a bottom split frame of the split iron frame door structure can be individually packaged. So, the packaging cost and the transportation cost are low. Furthermore, the iron frame door structure is light in overall weight, concise in appearance and good in light transmittance.

The technical scheme used to solve the technical problem in the disclosure is as follows. The split iron frame door structure includes a top split frame, a middle split frame and a bottom split frame which are detachably connected in sequence from top to bottom, wherein the top split frame includes two side edge frames, top glass, and a top edge frame which are connected as a whole; the middle split frame includes two side edge frames and middle glass which are connected as a whole; the bottom split frame includes two side edge frames, bottom glass, and a bottom edge frame which are connected as a whole; the top edge frame and the two side edge frames of the top split frame, the two side edge frames of the middle split frame and the bottom edge frame and the two side edge frames of the bottom split frame are thin-wall square tube frames; a bottom of the top split frame is fixed with a transversely-arranged first flat-iron edge frame; a top of the middle split frame is fixed with a transversely-arranged second flat-iron edge frame; a bottom of the middle split frame is fixed with a transversely-arranged third flat-iron edge frame; a top of the bottom split frame is fixed with a transversely-arranged fourth flat-iron edge frame; the first flat-iron edge frame and the second flat-iron edge frame are detachably connected through a first I-shaped section material and a plurality of first connecting screws; the first flat-iron edge frame is embedded in one notch of the first I-shaped section material; the second flat-iron edge frame is embedded in an other notch of the first I-shaped section material; the first flat-iron edge frame, a middle plate of the first I-shaped section material and the second flat-iron edge frame are fixedly connected in sequence from top to bottom through the first connecting screws; the third flat-iron edge frame and the fourth flat-iron edge frame are detachably connected through a second I-shaped section material and a plurality of second connecting screws; the third flat-iron edge frame is embedded in one notch of the second I-shaped section material; the fourth flat-iron edge frame is embedded in an other notch of the second I-shaped section material; and the third flat-iron edge frame, a middle plate of the second I-shaped section material and the fourth flat-iron edge frame are fixedly connected in sequence from top to bottom through the second connecting screws.

The split iron frame door structure in the disclosure adopts the split design. The top split frame, the middle split frame and the bottom split frame of the split iron frame door structure can be individually packaged, and can be transported to an installation site and then spliced and installed, so that the packaging cost and the transportation cost can be reduced.

The frames of the top split frame, the middle split frame and the bottom split frame of the split iron frame door structure in the disclosure are made of thin-wall square tubes and the flat iron, so that the thickness of the frames is reduced, the overall weight of the iron frame door is reduced, the appearance of the iron frame door is more concise, and the light transmittance of the iron frame door is improved.

The frames of connecting portions of the middle split frame, the top split frame and the bottom split frame are positioned in a thickness direction through the I-shaped section materials and the connecting screws. Furthermore, the I-shaped section materials can shield gaps generated due to insufficient flatness between the split frames after assembling, thereby ensuring the attractive appearance of the iron frame door.

Preferably, the top split frame, the middle split frame, the bottom split frame, the first flat-iron edge frame, the second flat-iron edge frame, the third flat-iron edge frame and the fourth flat-iron edge frame have same widths.

Preferably, the top edge frame and the two side edge frames of the top split frame as well as the first flat-iron edge frame are each fixed with two first flat-iron division bars, which are arranged at intervals and are configured for embedding and fixing the top glass; the two side edge frames of the middle split frame, the second flat-iron edge frame and the third flat-iron edge frame are each fixed with two second flat-iron division bars, which are arranged at intervals and configured for embedding and fixing the middle glass; and the bottom edge frame and the two side edge frames of the bottom split frame as well as the fourth flat-iron edge frame are each fixed with two third flat-iron division bars, which are arranged at intervals and configured for embedding and fixing the bottom glass.

Preferably, the top edge frame of the top split frame is fixedly connected with two trolley plates; a pulley is installed on each of the two trolley plates; the pulley is slidably erected on a guide rail fixed to a wall; one of the two side edge frames of the middle split frame is installed with a door handle; and the bottom edge frame of the bottom split frame is installed with a swing stopping device. The split iron frame door structure having the above-mentioned structure is applied to the sliding door system.

Compared with the prior art, the split iron frame door structure in the disclosure has the advantages as follows. The split iron frame door structure adopts the split design, and the top split frame, the middle split frame and the bottom split frame thereof can be individually packaged, and transported to an installation site and then spliced and installed, so that the packaging cost and the transportation cost can be reduced. The frames of the top split frame, the middle split frame and the bottom split frame of the split iron frame door structure are made of thin-wall square tubes and the flat iron, so that the thickness of the frames is reduced, the overall weight of the iron frame door is reduced, the appearance of the iron frame door is more concise, and the light transmittance of the iron frame door is improved.

### BRIEF DESCRIPTION OF THE DRAWINGS

FIG. 1 is an external appearance view of an iron frame door structure before assembling according to an embodiment of the disclosure;

FIG. 2 is an enlarged drawing of part A in FIG. 1;

FIG. 3 is an external appearance view of the iron frame door structure after assembling according to an embodiment of the disclosure;

FIG. 4 is a left view of FIG. 3;

FIG. 5 is a cross-sectional view taken along line B-B in FIG. 3;

FIG. 6 is an enlarged view of part C in FIG. 4;

FIG. 7 is an enlarged view of part D in FIG. 5;

FIG. 8 is an enlarged view of part E in FIG. 5;

FIG. 9 is an enlarged view of part F in FIG. 5; and

FIG. 10 is a view showing an effect of the iron frame door structure after installing in a third example.

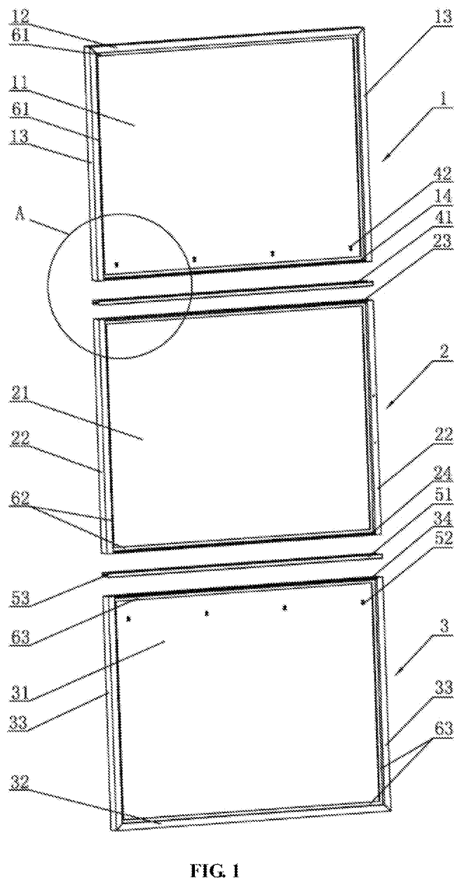

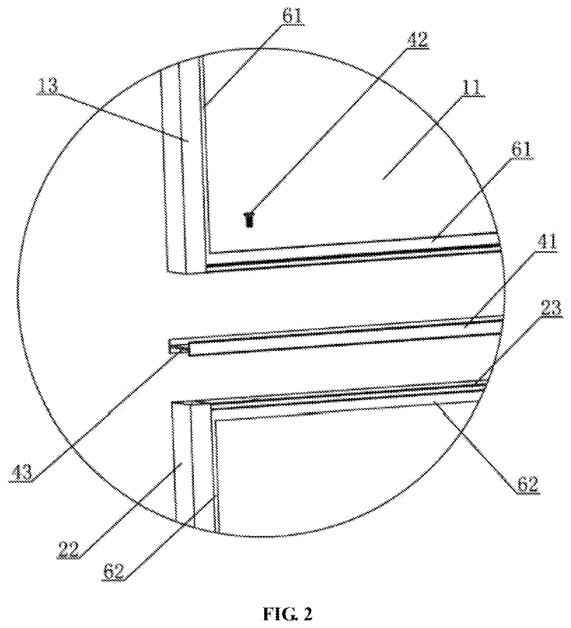

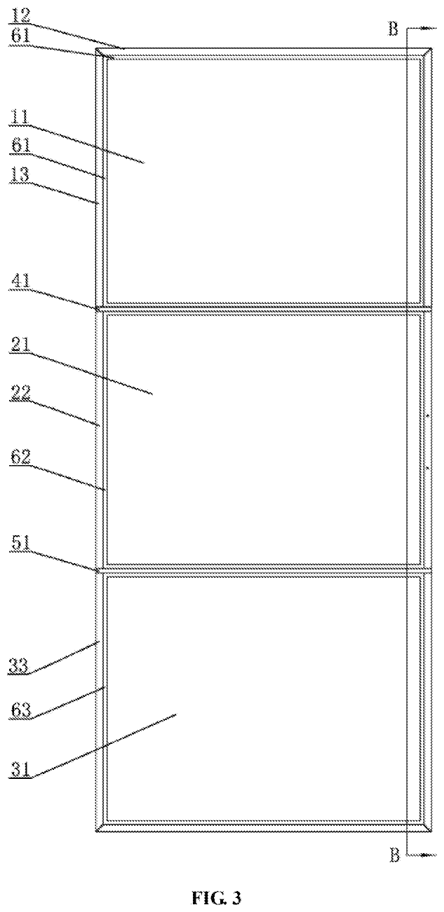

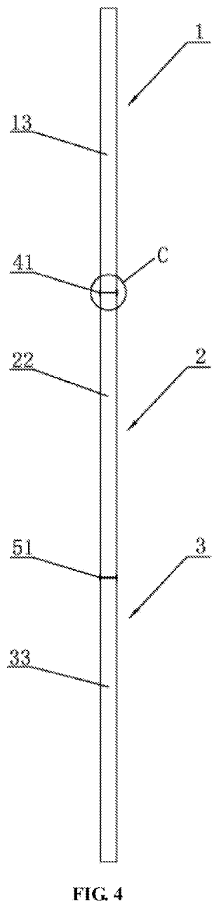

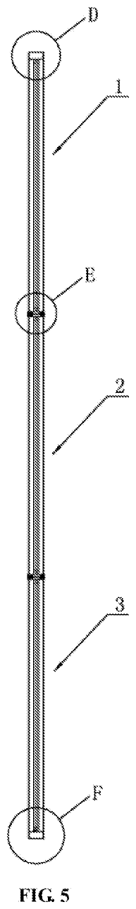

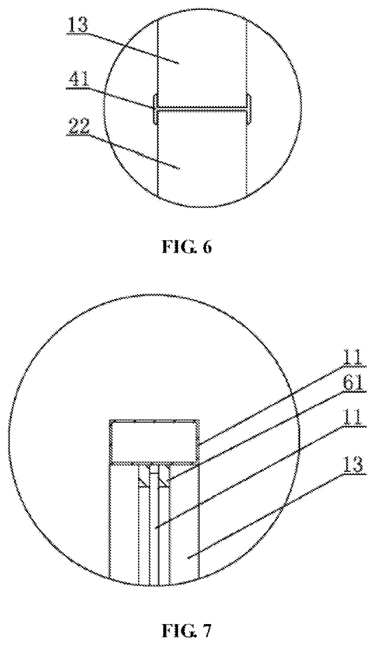

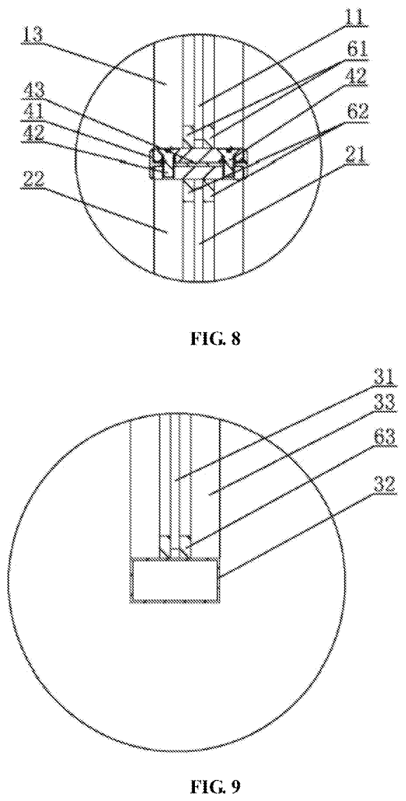

### DETAILED DESCRIPTION

The description of the disclosure is further described in conjunction with the following accompany drawings and embodiments.

A split iron frame door structure in the first example, as shown in figures, includes a top split frame 1, a middle split frame 2 and a bottom split frame 3 which are detachably connected in sequence from top to bottom. The top split frame 1 includes two side edge frames 13, top glass 11, and a top edge frame 12 which are connected as a whole. The middle split frame 2 includes two side edge frames 22 and middle glass 21 which are connected as a whole. The bottom split frame 3 includes two side edge frames 33, bottom glass 31, and a bottom edge frame 32 which are connected as a whole. The top edge frame 12 and the two side edge frames 13 of the top split frame 1, the two side edge frames 22 of the middle split frame 2, and the bottom edge frame 32 and the two side edge frames 33 of the bottom split frame 3 are thin-wall square tube frames. A transversely-arranged first flat-iron edge frame 14 is fixed to the bottom of the top split frame 1. A transversely-arranged second flat-iron edge frame 23 is fixed to the top of the middle split frame 2. A transversely-arranged third flat-iron edge frame 24 is fixed to the bottom of the middle split frame 2. A transversely-arranged fourth flat-iron edge frame 34 is fixed to the top of the bottom split frame 3. The first flat-iron edge frame 14 and the second flat-iron edge frame 23 are detachably connected through a first I-shaped section material 41 and a plurality of first connecting screws 42. The first flat-iron edge frame 14 is embedded in one notch of the first I-shaped section material 41, and the second flat-iron edge frame 23 is embedded in the other notch of the first I-shaped section material 41. The first flat-iron edge frame 14, a middle plate 43 of the first I-shaped section material 41 and the second flat-iron edge frame 23 are fixedly connected in sequence from top to bottom through the first connecting screws 42. The third flat-iron edge frame 24 and the fourth flat-iron edge frame 34 are detachably connected through a second I-shaped section material 51 and a plurality of second connecting screws 52. The third flat-iron edge frame 24 is embedded in one notch of the second I-shaped section material 51, and the fourth flat-iron edge frame 34 is embedded in the other notch of the second I-shaped section material. The third flat-iron edge frame 24, a middle plate 53 of the second I-shaped section material and the fourth flat-iron edge frame 34 are fixedly connected in sequence from top to bottom through the second connecting screws 52.

In the first example, the top split frame 1, the middle split frame 2, the bottom split frame 3, the first flat-iron edge frame 14, the second flat-iron edge frame 23, the third flat-iron edge frame 24 and the fourth flat-iron edge frame 34 are the same in width.

The difference between the split iron frame door structure in the second example and the split iron frame door structure in the first example is as follows. In the second example, the top edge frame 12 and the two side edge frames of the top split frame 1 as well as the first flat-iron edge frame 14 are each fixed with two first flat-iron division bars 61, which are arranged at intervals and are configured for embedding and fixing the top glass 11. The two side edge frames of the middle split frame 2, the second flat-iron edge frame 23 and the third flat-iron edge frame 24 are each fixed with two second flat-iron division bars 62. Which are arranged at intervals and configured for embedding and fixing the middle glass 21. The bottom edge frame and the two side edge frames of the bottom split frame 3 as well as the fourth flat-iron edge frame 34 are each fixed with two third flat-iron division bars 63, which are arranged at intervals and configured for embedding and fixing the bottom glass 31.

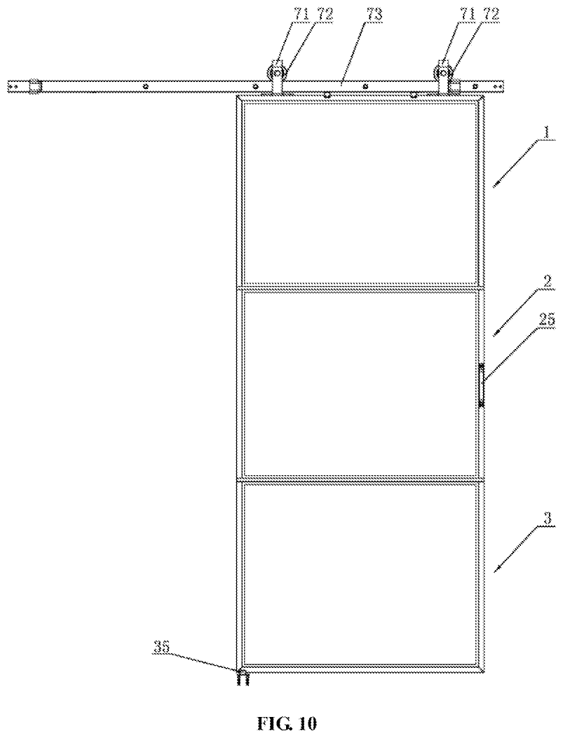

The difference between the split iron frame door structure in the third example and the split iron frame door structure in the second example is as follows. In the third example, the top edge frame 12 of the top split frame 1 is fixedly connected with two trolley plates 71. Each trolley plate 71 is installed with a pulley 72. The pulley 72 is slidably erected on a guide rail 73. The guide rail 73 is fixed to a wall. A door handle 25 is installed on one of the side edge frames of the middle split frame 2. And a swing stopping device 35 is installed on the bottom edge frame 32 of the bottom split frame 3. The split iron frame door structure in the third example is specifically applied to sliding door systems, and the effect after the split iron frame door structure is installed is as shown in FIG. 10.

What is claimed is:

1. A split iron frame door structure, comprising a top split frame, a middle split frame and a bottom split frame which are detachably connected in sequence from top to bottom, wherein the top split frame comprises two side edge frames, top glass, and a top edge frame which are connected as a whole; the middle split frame comprises two side edge frames and middle glass which are connected as a whole; the bottom split frame comprises two side edge frames, bottom glass, and a bottom edge frame which are connected as a whole; the top edge frame and the two side edge frames of the top split frame, the two side edge frames of the middle split frame and the bottom edge frame and the two side edge frames of the bottom split frame are thin-wall square tube frames; a bottom of the top split frame is fixed with a transversely-arranged first flat-iron edge frame; a top of the middle split frame is fixed with a transversely-arranged second flat-iron edge frame; a bottom of the middle split frame is fixed with a transversely-arranged third flat-iron edge frame; a top of the bottom split frame is fixed with a transversely-arranged fourth flat-iron edge frame; the first flat-iron edge frame and the second flat-iron edge frame are detachably connected through a first I-shaped section material and a plurality of first connecting screws; the first flat-iron edge frame is embedded in one notch of the first I-shaped section material; the second flat-iron edge frame is embedded in an other notch of the first I-shaped section material; the first flat-iron edge frame, a middle plate of the first I-shaped section material and the second flat-iron edge frame are fixedly connected in sequence from top to bottom through the first connecting screws; the third flat-iron edge frame and the fourth flat-iron edge frame are detachably connected through a second I-shaped section material and a plurality of second connecting screws; the third flat-iron edge frame is embedded in one notch of the second I-shaped section material; the fourth flat-iron edge frame is embedded in an other notch of the second I-shaped section material; and the third flat-iron edge frame, a middle plate of the second I-shaped section material and the fourth flat-iron edge frame are fixedly connected in sequence from top to bottom through the second connecting screws.

2. The split iron frame door structure according to claim 1, wherein the top split frame, the middle split frame, the bottom split frame, the first flat-iron edge frame, the second flat-iron edge frame, the third flat-iron edge frame and the fourth flat-iron edge frame have same widths.

3. The split iron frame door structure according to claim 1, wherein the top edge frame and the two side edge frames of the top split frame as well as the first flat-iron edge frame are each fixed with two first flat-iron division bars, which are arranged at intervals and are configured for embedding and fixing the top glass; the two side edge frames of the middle split frame, the second flat-iron edge frame and the third flat-iron edge frame are each fixed with two second flat-iron division bars, which are arranged at intervals and configured for embedding and fixing the middle glass; and the bottom edge frame and the two side edge frames of the bottom split frame as well as the fourth flat-iron edge frame are each fixed with two third flat-iron division bars, which are arranged at intervals and configured for embedding and fixing the bottom glass.

4. The split iron frame door structure according to claim 1, wherein the top edge frame of the top split frame is fixedly connected with two trolley plates; a pulley is installed on each of the two trolley plates; the pulley is slidably erected on a guide rail fixed to a wall; one of the side edge frames of the middle split frame is installed with a door handle; and the bottom edge frame of the bottom split frame is installed with a swing stopping device.
